(19) United States
(12) Patent Application Publication
(10) Pub. No.: US 2013/0081934 A1
(43) Pub. Date: Apr. 4, 2013

(54) SYSTEMS AND METHODS FOR CONVERTING SEWAGE SLUDGE INTO A COMBUSTIBLE FUEL

(71) Applicant: Levi New, Kalamazoo, MI (US)

(72) Inventor: Levi New, Kalamazoo, MI (US)

(73) Assignee: PULVERDRYER USA, INC., Springfield, MI (US)

(21) Appl. No.: 13/645,159

(22) Filed: Oct. 4, 2012

Related U.S. Application Data
(60) Provisional application No. 61/542,971, filed on Oct. 4, 2011.

(51) Int. Cl. C10L 5/46; C10B 53/00; C10L 5/44; B30B 11/00; C10B 45/00; C10B 57/00

(52) U.S. Cl. 201/8; 202/96; 201/25; 44/589; 44/590; 44/605; 44/606; 44/636

(57) ABSTRACT

According to various embodiments, systems and methods are provided for converting sewage, sludge, wet feedstock, animal waste, municipal trash, and/or other biomasses into combustible fuels. According to various embodiments, sewage is dewatered, pulverized, desiccated, pelletized, and/or subjected to pyrolysis in order to produce bio-fuels, combustible gases, and/or chars. Bio-fuels, gases and/or chars may be collected during and/or after pyrolysis for use as combustible fuels. According to various embodiments, the collected bio-fuels, gases and/or chars may be transported for later use as a fuel. The collected gases may be liquefied and transported for later use as a fuel.

### RELATED APPLICATIONS

This U.S. patent application claims priority under 35 U.S.C. §119(e) to U.S. Provisional Application No. 61/542,971 filed on Oct. 4, 2011, titled “SYSTEMS AND METHODS FOR CONVERTING SEWAGE SLUDGE INTO A COMBUSTIBLE FUEL,” which is hereby incorporated by reference in its entirety.

In addition, this application hereby incorporates the following United States patents and patent applications by reference in their entireties: U.S. Pat. No. 6,722,594, filed Feb. 26, 2001, titled “PULVERISER AND METHOD OF PULVERIZING”; U.S. Pat. No. 6,978,953, filed Jan. 5, 2004, titled “PULVERISER AND METHOD OF PULVERIZING”; U.S. Pat. No. 7,059,550, filed Nov. 12, 2003, titled “SYSTEM AND METHOD FOR PULVERISING AND EXTRACTING MOISTURE”; U.S. Pat. No. 7,040,557, filed Apr. 1, 2004, titled “SYSTEM AND METHOD FOR PULVERISING AND EXTRACTING MOISTURE”; U.S. Pat. No. 7,374,113, filed Dec. 9, 2005, titled “PULVERISING AND EXTRACTING MOISTURE”; U.S. Pat. No. 7,137,580, filed Nov. 15, 2005, titled “SYSTEM AND METHOD FOR PULVERISING AND EXTRACTING MOISTURE”; U.S. Pat. No. 7,429,008, filed Jun. 30, 2006, titled “SYSTEM AND METHOD FOR PULVERISING AND EXTRACTING MOISTURE”; U.S. Pat. No. 7,500,830, filed Jul. 27, 2007, titled “SYSTEM AND METHOD FOR PULVERISING AND EXTRACTING MOISTURE”; U.S. Pat. No. 7,909,577, filed Apr. 1, 2009, titled “SYSTEM AND METHOD FOR PULVERISING AND EXTRACTING MOISTURE”; U.S. Patent Publication No. 2009/0008312, filed Jul. 3, 2007, titled “WASTE TREATMENT SYSTEM”; U.S. Patent Publication No. 2010/0096336, filed Oct. 22, 2008, titled “WASTE TREATMENT SYSTEM”; U.S. Patent Publication No. 2011/0094395, filed Oct. 26, 2009, titled “METHOD AND ATTACHMENT FOR DEWATERING LOGS”; U.S. Patent Publication No. 2011/0084029, filed Oct. 8, 2009, titled “WASTE TREATMENT SYSTEM”; and U.S. Patent Publication No. 2011/0089097, filed Oct. 19, 2009, titled “ATTACHMENT AND SYSTEM FOR DEWATERING MATERIAL.”

### TECHNICAL FIELD

The present disclosure relates generally to the dewatering, pulverizing, and pyrolysis of biomasses, such as sewage sludge.

### BRIEF DESCRIPTION OF THE DRAWINGS

Non-limiting and non-exhaustive embodiments of the disclosure are described herein, including various embodiments of the disclosure with reference to the figures listed below.

FIG. 1 illustrates a block diagram of an exemplary system for converting raw sewage, or other biomass, into a combustible fuel.

FIG. 2 illustrates a block diagram of various exemplary systems for dewatering raw sewage sludge to between approximately 40 and 60 percent solid content.

FIG. 3 illustrates a cross-sectional view of an exemplary pulverizing system including a venturi receiving sewage sludge comprising between approximately 40 and 60 percent solid content.

FIG. 4 illustrates a side view of another exemplary embodiment of a pulverizing system configured to pulverize and desiccate sewage sludge.

FIG. 5 illustrates a block diagram of an exemplary system for performing pyrolysis on a biomass, such as powdered sewage.

FIG. 6 provides a flow chart of an exemplary method for converting raw sewage, or other biomass, into a transportable combustible fuel.

FIG. 7 provides a flow chart of another exemplary method for converting raw sewage, or other biomass, into a combustible fuel or high-grade carbon product.

FIG. 8 provides a flow chart of an exemplary method for converting raw sewage, or other biomass, into a combustible fuel or high-grade carbon product.

In the following description, numerous specific details are provided for a thorough understanding of the various embodiments disclosed herein. The systems and methods disclosed herein can be practiced without one or more of the specific details, or with other methods, components, materials, etc. In some cases, well-known structures, materials, or operations may not be shown or described in detail in order to avoid obscuring aspects of the disclosure. Furthermore, the described features, structures, or characteristics may be combined in any suitable manner in one or more alternative embodiments.

### DETAILED DESCRIPTION

The present disclosure provides various systems and methods for converting sewage, sludge, wet feedstock, animal waste, municipal trash, and/or other high-BTU biomasses into a combustible fuel. Although many types of biomasses are contemplated, the following description utilizes sewage sludge as an example of a suitable biomass.

According to various embodiments, sewage sludge may be dewatered, desiccated, pulverized, and subjected to pyrolysis in order to produce combustible gases and/or chars. Gases and chars may be collected during and after pyrolysis for use as fuels. According to various embodiments, the powdered sewage may be pelletized and the gases collected during pyrolysis may be liquefied.

The raw sewage may be preprocessed by removing free-flowing liquids. Any number of methods may be used to remove the free-flowing liquids from the raw sewage, including draining, drying, compressing, straining, spill-over, and other dewatering methods. In various embodiments, after removing the free-flowing liquids, the material (e.g., sewage sludge) may contain 25 percent or less solid content.

The sewage sludge (or other material) may be dewatered using any of a variety of natural and/or mechanical means. For example, sewage sludge may be dewatered using a screw press or a Hydrocell press, and/or by blending a material with the sewage sludge. According to various embodiments, plastic, sawdust, particleboard, and/or other material may be blended with the sewage sludge to create channels. The channels may be configured to allow for an increased release of liquids during mechanical or chemical dewatering. According to various embodiments, coal may be combined with the sewage sludge to increase the percentage of solids prior to pulverization as well as to increase the potential energy of the final combustible fuel product.

In some embodiments, a pulverizing system may be capable of receiving material having any ratio of liquids and solids. In other embodiments, a pulverizing system may be more efficient when the input material has a minimum percentage of solid content by volume and/or weight. The natural and/or mechanical dewatering processes described herein may be adapted to meet the requirements of a particular pulverizing system. According to one embodiment, dewatered sewage sludge is reduced to at least approximately 40 percent solid content by weight or volume prior to being pulverized and/or desiccated.

According to various embodiments, the efficiency of a pulverizing system may be significantly increased when the percentage of solid content is at least approximately 60 percent. If the initial biomass, such as sewage sludge, contains sufficient solid content without undergoing the removal of free-flowing liquid and/or without undergoing a dewatering process, then those steps may be omitted from the process. Otherwise, the removal of free-flowing liquids and/or dewatering may be performed in order to achieve a minimally required percentage of solid content (e.g., 40 percent) or a recommended percentage of solid content (e.g., 60 percent as described above).

Once the percentage of solids in the sewage sludge is sufficient, a pulverizing system may be used to pulverize the dewatered sewage sludge to produce a “powder.” The term “powder” as used herein means relatively fine loose particles. For example, the powder may include or be crumbs, dust, grains, grit, particles, loose particles, granules, gilings, and/or pulverulence.

According to various embodiments, the pulverized sewage sludge is simultaneously desiccated. The sewage sludge may be pulverized and/or desiccated multiple times and/or mixed with incoming dewatered sewage sludge until a desired consistency is achieved. According to various embodiments, the pulverization may result in sewage sludge in the form of a homogenous desiccated powder. According to one embodiment, the homogenous desiccated sewage sludge is at least 75 percent solid content.

The pulverized and desiccated sewage sludge may then undergo pyrolysis. Pulverizing and/or desiccating the sewage sludge (or other biomass) prior to pyrolysis may increase the efficiency of the pyrolysis and the pyrolysis may be more evenly applied to the sewage sludge. The char resulting from the pyrolysis may be collected, stored, burned, transported, and/or otherwise removed from a pyrolysis chamber.

The char resulting from the pyrolysis may be collected and kept in a powder to facilitate transportation and post-processing. For example, the powdered char may be transported and used to fuel a boiler system. Alternatively, the char may be discarded, compressed, mixed with other content, and/or stored.

Any of a wide variety of systems and/or methods of pyrolysis may be utilized, such as flash pyrolysis. During pyrolysis, the pulverized sewage sludge becomes a char containing a relatively high carbon content. In some embodiments, one or more of the gases produced during pyrolysis may be collected. The collected gases suitable as combustible fuels may be stored and/or transported to another location for use as a combustible. Alternatively, the collected gases suitable as combustible fuels may be liquefied on site or at another location for later use as a combustible. For example, the collected gases may be processed into a syngas, a biodiesel, and/or a jet fuel. Additionally, higher-grade carbons may be separated and/or liquefied for later use as combustibles. According to various embodiments, the resulting combustible gases may be liquefied without any sulfur. Low- or no-sulfur combustible gases/liquids may be less harmful to burner and exhaust components, the environment, and/or better align with environmental regulations.

Additionally, the resulting char, which may be in the form of a powder, may be burned off, blown into a boiler, re-pulverized, mixed with sewage sludge prior to mechanical dewatering, mixed with sewage sludge prior to pulverization, and/or transported to another location for use as a combustible fuel. According to some embodiments, one or more gases collected during pyrolysis may be filtered in order to reduce emissions and/or waste of certain materials. Additionally, adding a high-grade combustible material such as coal to the powdered char may increase the energy content of the final combustible fuel product. High-grade combustible materials may be added at various points during the process. For example, coal may be blended with the raw sewage sludge prior to, during, and/or after dewatering, pulverizing, and/or pyrolysis.

Reference throughout this specification to “one embodiment,” “an embodiment,” or “various embodiments” means that a particular feature, structure, or characteristic described in connection with the embodiment is included in at least one embodiment. Thus, the appearances of the phrases “in one embodiment” or “in an embodiment” in various places throughout this specification may be, but are not necessarily all, referring to the same embodiment. In particular, an embodiment may be a system, an article of manufacture, a method, and/or a product of a process.

In some cases, well-known features, structures, or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of configurations.

The embodiments of the disclosure may be understood by reference to the drawings, wherein like parts are designated by like numerals throughout. It will be readily understood that the components of the disclosed embodiments, as generally described and illustrated in the figures herein, could be arranged and designed in a wide variety of configurations. Thus, the following detailed description of the systems' embodiments and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless specifically stated.

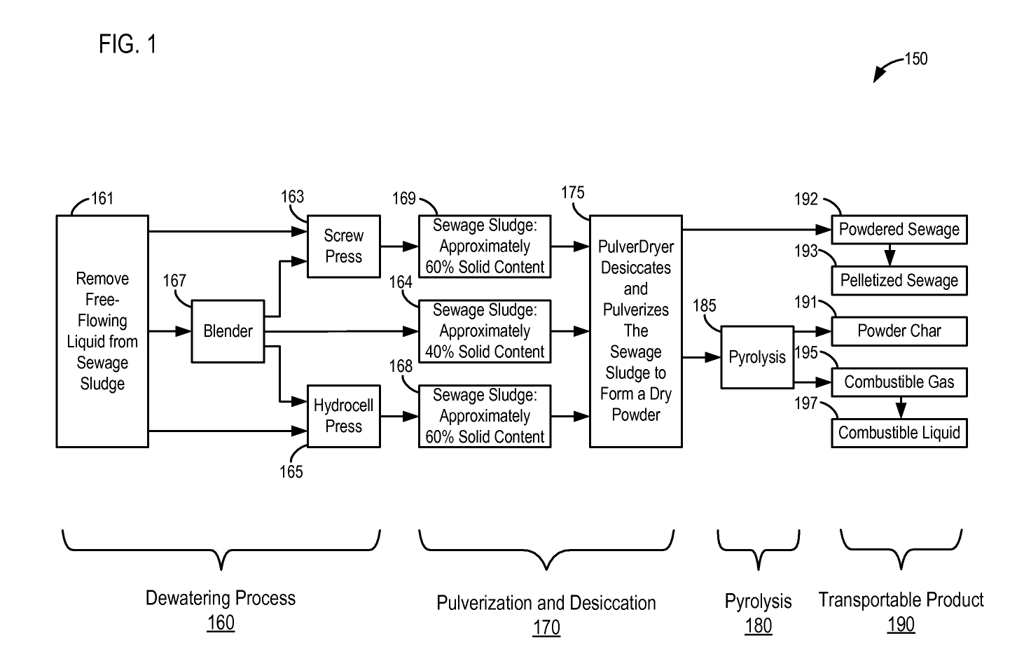

FIG. 1 illustrates a block diagram of an exemplary system 150 for converting raw sewage sludge or other biomass into a combustible fuel. According to various embodiments, the combustible fuel product generated from the raw sewage may be transported to another location for later use. As illustrated in FIG. 1, raw sewage may be converted into a transportable product 190 by undergoing a dewatering process 160, followed by pulverization and/or desiccation 170, and then (optionally) pyrolysis 180.

A dewatering process 160 may include receiving raw sewage (or other biomass) having a relatively low percentage of solids, such as between 15 and 25 percent. According to various embodiments, a pulverizing machine, such as a system manufactured by PulverDryer USA, Inc., may operate more efficiently when the percentage of solids received exceeds approximately 40 percent, and may operate with increased efficiency if the percentage of solids exceeds approximately 60 percent. Accordingly, the dewatering process 160 may be configured to remove approximately between 60 and 99 percent of the liquid within the raw sewage.

A preprocessing step may be used to remove free-flowing liquid from the sewage sludge, at 161. Any number of methods may be used to remove the free-flowing liquids from the sewage sludge, including draining and drying methods. Depending on the initial material and the sewage plant processing methods used, the sewage sludge may contain 20 to 25 percent or less liquid content after removing the initial free-flowing liquids. Some biomasses may not contain any free-flowing fluids and may accordingly be initially processed mechanically.

A second step for dewatering may include any of a wide variety of natural and/or mechanical processes. For example, sewage sludge may be dewatered using a screw press 163 or a Hydrocell press 165, and/or by blending 167 a material with the sewage sludge. According to various embodiments, plastic, sawdust, particleboard, and/or other material(s) may be blended with the sewage sludge to create channels configured to increase the release of liquids during mechanical dewatering. According to one embodiment, coal may be combined, via the blender 167, with the sewage sludge to increase the percentage of solids prior to pulverization as well as to increase the potential energy of the final combustible fuel product.

According to various embodiments, a pulverization system may require, recommend, and/or operate with increased efficiency with an input material that has a minimum percentage of solid content by volume and/or weight. Accordingly, the natural and/or mechanical dewatering processes may be adapted to meet the requirements or recommendations of a particular pulverization system. For example, dewatered sewage sludge may be reduced to at least approximately 40 percent solid content 164 by weight or volume prior to being pulverized and/or desiccated. According to various embodiments, the efficiency of the pulverizing system may be greatly increased when the percentage of solid content is approximately 60 percent or greater. According to the illustrated embodiment, after mechanical dewatering, the resulting sewage sludge may comprise approximately 60 percent solid content 168 and 169.

As illustrated, the blender 167 may be used to form sewage sludge comprising approximately 40 percent solid content 164. The blended sewage sludge may then be fed into the screw press 163 or the Hydrocell press 165 to form sewage sludge comprising approximately 60 percent solid content, at 168 and 169. Alternatively, the sewage sludge may be directly processed using the screw press 163 and/or the Hydrocell press 165.

The dewatered sewage sludge may then be fed into a pulverizing system 175 in order to produce a powdered sewage 192. According to various embodiments, the sewage sludge may be simultaneously desiccated as it is pulverized. The sewage sludge may be pulverized and/or desiccated multiple times and/or mixed with incoming dewatered sewage sludge until a desired consistency is achieved. According to various embodiments, the pulverization system may be configured to produce sewage sludge in the form of a homogenous desiccated powder 192. According to one embodiment, the homogenous desiccated sewage sludge may comprise at least 75 to 85 percent solid content. Additionally, a pulverization system may be configured to greatly reduce the number of bacteria and/or pathogens within the powdered sewage. According to various embodiments, the powdered sewage 192 may be pelletized 193.

According to various embodiments, the pulverized and desiccated sewage sludge may undergo pyrolysis 185. Any of a wide variety of systems and/or methods of pyrolysis may be utilized, such as flash pyrolysis, batch pyrolysis, or continuous-feed pyrolysis. Pulverizing and/or desiccating the sewage sludge (or other biomass) prior to pyrolysis may increase the efficiency of the pyrolysis system. Additionally, the collected char resulting from the pyrolysis may remain in a powder form, facilitating further processing and/or transportation. During pyrolysis 185, the pulverized sewage sludge may be converted into a combustible powdered char 191 and various gases 195, each of which may contain a relatively high carbon content. The BTU value of the char may be increased from the powdered sewage sludge and the water may be completely eliminated. One or more of the gases 195 produced during pyrolysis may be collected. According to various embodiments, the collected gases 195 suitable as combustible fuels may be stored and transported to another location for use as a combustible. Alternatively, the collected gases 195 may be liquefied 197 on site or at another location for later use as a combustible. For example, the collected gases 195 may be processed into a syngas, a biodiesel, a jet fuel, and/or other combustible liquid 197.

Additionally, the resulting powdered char 191 may be burned off, fed into a boiler, re-pulverized 175, used as a blending agent, and/or transported to another location for use as a combustible fuel. For example, the powdered char 191 may be blended with sewage sludge 167 prior to mechanical dewatering or mixed with sewage sludge prior to or during pulverization.

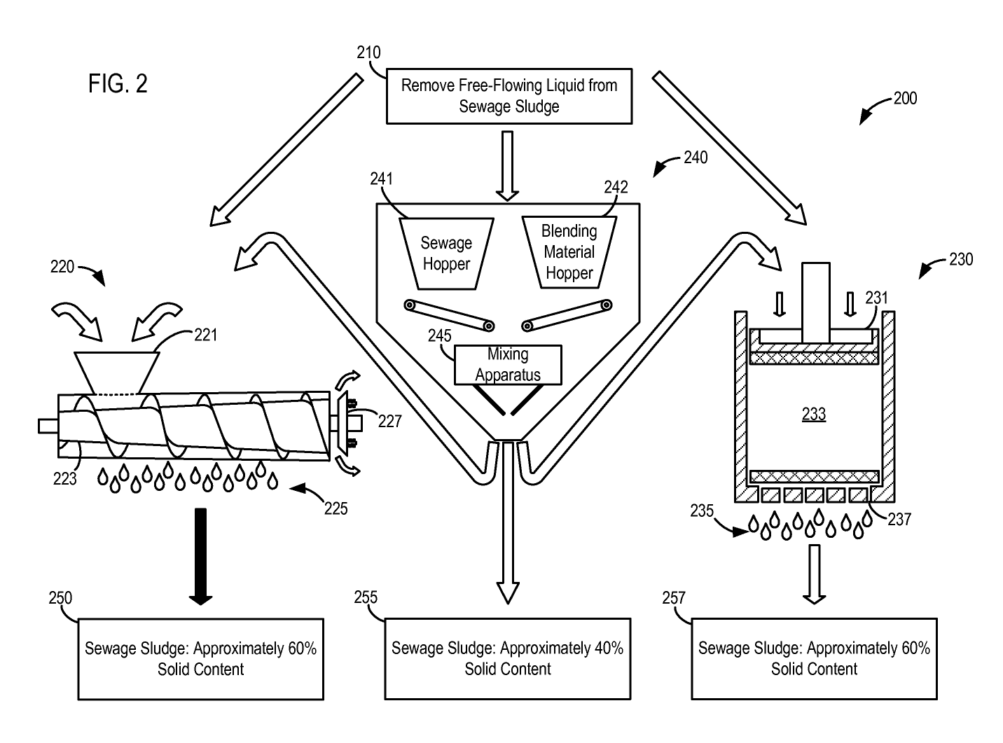

FIG. 2 illustrates a block diagram 200 of various exemplary systems 220, 230, and 240 for converting raw sewage into a dewatered sewage sludge comprising between approximately 40 and 60 percent solid content, at 250. As illustrated and as previously described, an initial step may include removing free-flowing liquid from the raw sewage, at 210. Once the free-flowing liquid is removed, one or more mechanical systems may be used to further reduce the liquid content of the sewage sludge.

One method for increasing the percentage of solid content in sewage sludge is to blend solid material or solidifying material with the sewage. A blender system 240 may include a sewage hopper 241 configured to receive sewage sludge and a blending material hopper 242 configured to receive a blending material. A mixing apparatus 245 may blend the sewage sludge and the blending material until the resulting combination contains approximately 60 percent solid content by weight or volume. Alternatively, a blender system 240 may be used to increase the percentage of solid content to less than a 60 percent solid state 255 (e.g., 40 percent as illustrated) after which the sewage sludge may be fed into a screw press 220 or a Hydrocell press 230, and/or otherwise further dewatered.

Any of a wide variety of screw presses 220 may be employed and may utilize various advanced features and/or improvements over the relatively basic screw press 220. As illustrated, a hopper 221 may be configured to receive the raw sewage 210 or the blended sewage sludge 255 after which a rotating screw 223 may advance and compress the sewage sludge toward the backpressure valve 227. As the sewage sludge is compressed against the backpressure valve 227, liquid 225 trapped within the sewage sludge may be released and drained from the screw press 220. Sewage sludge that ultimately emerges from the screw press 220 around the backpressure valve 227 may contain between approximately 40 and 60 percent solid content by weight or volume, at 250.

Another type of mechanical dewatering system that may be utilized is a dewatering press 230 manufactured by Hydrocell Technologies. A more detailed description of a Hydrocell dewatering system may be found in a number of the incorporated patents and patent applications cited above. However, for convenience, a simplified version of a Hydrocell press 230 is illustrated in FIG. 2. As illustrated in the simplified schematic, a press 231 may compress raw sewage 210 or blended sewage sludge 255 within a chamber 233 to force trapped liquids 235 out of the sewage sludge and expel them from the chamber 233 via holes 237 (e.g., vias). The resulting dewatered sewage sludge may contain approximately 60 percent solid content by weight or volume, at 257. The sewage may be mechanically fed through the press, such as via a conveyer belt

In various embodiments, a first mechanical compression machine may be used to compress the biomass to dewater it at least partially. After dewatering the biomass by the first mechanical compression machine, a blending material (e.g., a compressible blending material) may be mixed with the biomass, such that it is evenly distributed. A compression apparatus may use a ram and a plate press. The plate press may include a plurality of apertures vertically disposed below the compression ram to enable gravitational pull of water through the apertures. A porous material may be disposed on the plate press to cover the plurality of apertures. The biomass (and possibly a blending material) may then be compressed by the compression ram against the plate press to release liquid through the apertures. In some embodiments, the compressive force may be between approximately 100 pounds per square inch (PSI) and 1000 PSI. Additional pressure may increase the amount of liquids released from the biomass. The plate press may include a conveyer belt configured to continuously or batch feed the biomass into the compression apparatus.

The blending material may be a cellulose-based material treated with urea formaldehyde resin, wood shavings, newsprint and milled peat, trommel fines, open-cell sponges, dust collected from the machining of medium density fiberboard (MDF). The weight ration of the biomass to the blending material may be between 2:1 and about 10:1.

The screw press 220, the Hydrocell press 230, and the blender system 240 are merely examples of methods for dewatering sewage sludge to a sufficient extent for the sewage sludge to be processed by a pulverizing system. Any number of alternative and/or improved dewatering methods and/or systems may be utilized in combination with the presently described methods for converting sewage sludge into a combustible fuel.

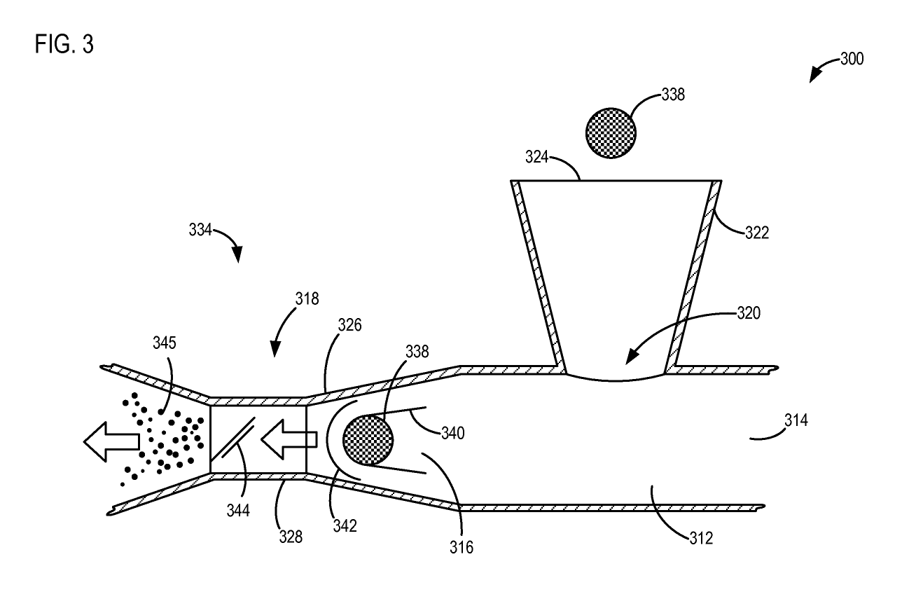

FIG. 3 illustrates a cross-sectional side view of an exemplary pulverizing system 300 including a venturi 318 receiving sewage sludge material 338 via an opening 324. The sewage sludge material 338 may be approximately 60 percent solid material. In operation, the material 338 is introduced into the inlet tube 312 through any number of conveyance methods. The material 338 may be a solid or a semi-solid. The airflow generator may generate an air stream, ranging from 350 mph to supersonic, which flows through the inlet tube 312 and through the venturi 318. In the venturi 318, the airflow velocity substantially accelerates. The material 338 is propelled by the high-speed airflow to the venturi 318. The material 338 is smaller in diameter than the interior diameter of the inlet tube 312 and a gap exists between the inner surface of the inlet tube 312 and the material 338.

As the material 338 enters the converging portion 326, the gap becomes narrower and eventually the material 338 causes a substantial reduction in the area of the converging portion 326 through which air can flow. A recompression shock wave 340 trails rearward from the material and a bow shock wave 342 builds up ahead of the material 338. Where the converging portion 326 merges with the throat 328 there is a standing shock wave 344. The action of these shock waves 340, 342, and 344 impacts the material 338 and results in pulverization and moisture extraction from the material. The pulverized material 345 continues through the venturi 318 and exits into the airflow generator.

The material size reduction depends on the material to be pulverized and the dimensions of the system 300. By increasing the velocity of the airflow, pulverization and particle size reduction increases with certain materials. Thus, the system 300 allows the user to vary desired particle dimensions by altering the velocity of the airflow.

The system 300 has particular application in pulverizing solid materials into a fine dust or powder. The system 300 has further application in extracting moisture from semi-solid materials such as municipal waste, paper sludge, animal by-product waste, fruit pulp, and so forth. The system 300 may be used in a wide range of commercial and industrial applications.

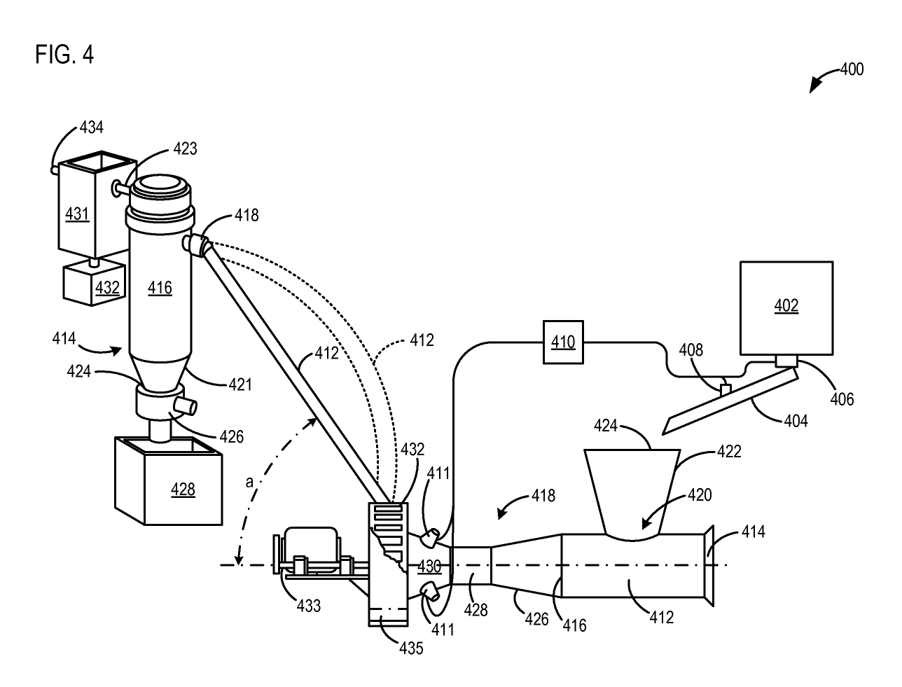

FIG. 4 illustrates a side view of another exemplary embodiment of a pulverizing system 400 configured to pulverize and desiccate sewage sludge that is at least 40 percent solid. Pulverizing system 400 may be used to extract moisture from materials. The system 400 may include a blender 402 for mixing materials in a preprocessing stage. Raw material may include polymers and/or plastics that tend to lump the material into granules. The granules may be oversized and, due to the polymers, resist breaking down into a desired powder form.

The presence of polymers is typical with municipal waste as polymers are introduced during sewage treatment to bring the waste particles together. Waste may be processed on a belt press resulting in a material that is mostly semi-solid. In some processes, the material may be approximately 15 to 20 percent solid and the remainder moisture.

In the preprocessing stage, a drying enhancing agent is mixed with the raw material to break down the polymers and the granulation of the material. Non-polymerized products may be processed without the blending. Raw material is introduced into the blender 402 that mixes the material with a certain amount of a drying enhancing agent. The drying enhancing agent may be selected from a wide range of enhancers such as attapulgite, coal, lime, and the like. The drying enhancing agent may also be a pulverized and dried form of the raw material. The blender 402 mixes the material with the drying enhancing agent to produce an appropriate moisture content and granular size.

The raw material is transferred from the blender 402 to the hopper 422 by any number of methods including use of a conveyance device 404, such as a belt conveyor, screw conveyor, extruder, or other motorized device. In the illustrated embodiment, the conveyance device 404 is an inclined track that relies on gravity to deliver raw material to the hopper 422. The conveyance device 404 is positioned below a flow control valve 406 located on the lower portion of the blender 402.

In an alternative embodiment, the hopper 422 may be eliminated and material is delivered directly to the elongated opening 420 of the inlet tube 412. The hopper 422 is only one device that may be used to facilitate delivery of material to the inlet tube 412. Any number of other conveyance devices may be used as well as manual delivery.

One or more sensors 408 may monitor the flow rate of material passing from the blender 402 to the inlet tube 412. A sensor 408 is in communication with a central processor 410 to regulate the flow rate. The sensor 408 may be disposed proximate to the conveyance device 404, proximate to the hopper 422, within the hopper 422, or even between the hopper 422 and the elongated opening 420 to monitor the material flow rate. The central processor 410 is in communication with the flow control valve 406 to increase or decrease the flow rate as needed. Alternative methods for monitoring and controlling the flow rate may also be used including visual inspection and manual adjustment of the flow control valve 406.

The hopper 422 receives the material and delivers the material to the elongated opening 420 of the inlet tube 412. The elongated opening 420 may be equal to or less than 4″ wide and 5″ long to maintain an acceptable feed flow for certain applications. The length of inlet tube 412 from the elongated opening 420 to the venturi 418 may range from 24″ (610 mm) to 72″ (1830 mm) or more depending on the material to be processed and the flow rate. One of skill in the art will appreciate that the dimensions are for illustrated purposes only as the system 400 is scalable and/or may be adapted for a particular application.

The airflow pulls the material from the inlet tube 412 through the venturi 418. In the illustrated embodiment, the first end 414 is configured as a flange to converge from a diameter greater than the inlet tube 412 to the diameter of the inlet tube 412. The flange-configured first end 414 increases airflow volume into the inlet tube 412.

Certain embodiments have the throat diameter of the venturi 418 ranging from approximately 1.5″ (38 mm) to approximately 6″ (152 mm). The throat diameter is scalable based on material flow volume and may exceed the previously stated range. The throat diameter of the venturi 418 and the inlet tube 412 are directly proportional. In one embodiment, the throat diameter is 2.75″ and operates with an inlet tube diameter of 5.5″ (139.33 mm). In an alternative embodiment, the throat diameter may be 2.25″ (57 mm) and operate properly with an inlet tube diameter of 4.5″ (114 mm). Thus, a 2 to 1 ratio ensures that raw feed material is captured in the incoming airflow.

In the illustrated embodiment, the diverging section 430 couples to the housing 435 and communicates directly with the housing 435. The final diameter of the diverging section 430 is not necessarily the same as the inlet tube 412. In an alternative embodiment, the diverging section 430 may couple to an intermediary component, such as a cylinder, tube, or pipe, prior to coupling with the housing 435.

One or more flow valves 411 may be disposed on the diverging section 430 and provide additional air volume into the interior of the housing 435 and the airflow generator 432. The additional air volume increases the performance of the airflow generator 432. In one embodiment, two flow valves 411 are disposed on the diverging section 430. The system 400 may be operated with the flow valves 411 partially or completely opened. If material begins to obstruct the venturi 418, the flow valves 411 may be closed. This results in more airflow through the venturi 418 to provide additional force and drive material through the venturi 418 and the airflow generator 432. The flow valves 411 are adjustable and are shown in electrical communication with the central processor 410 for control. According to various embodiments, the flow valves 411 may be manually operated or utilize computer automation, which may greatly facilitate the process.

The venturi 418 provides a point of impact between higher velocity shock waves and lower velocity shock waves. The shock waves provide a pulverization and moisture extraction event within the venturi 418. In operation, there may be no visible signs of moisture on the interior of the venturi 418 or in the housing outlet. The pulverization event further reduces the size of materials. For example, materials having a diameter of 2″ (50 mm) entering the venturi 418 may be reduced to a fine powder with a diameter of 20 μm in one pulverization event. Size reduction may depend on the material being processed and the number of pulverization events. Separating liquid from the material may result in material dehydration and greatly reduce the number of pathogens. The possible applications for the presently described systems and methods reach through a number of industries in addition to sewage sludge and other types of municipal waste.

The presently described pulverizing system 400 has particular application in processing municipal waste, such as sewage sludge. The preprocessing step of blending a drying enhancing agent provides a waste material that is readily processed by the system 400. The pulverizing and moisture extraction process may reduce the number of pathogens in the waste material by rupturing their cell wall. A second source of pathogen reduction is moisture extraction, which reduces the pathogens. Using the presently described systems and methods, the majority or all of total coliform, fecal coliform, escherichia coli, and other pathogens may be eliminated.

The material, moisture, and air stream proceed through the airflow generator 432 and exit through the housing outlet. The housing outlet is coupled to an exhaust pipe 412 that delivers the material to a cyclone 414 for material and air separation. In one embodiment, the diameter of the exhaust pipe 412 may range from approximately 4″ (100 mm) to 7″ (177 mm). A larger exhaust pipe may be employed, especially with materials such as attapulgite or coal. Although referred to as a pipe, one of skill in the art will appreciate that the exhaust pipe 412 may have a cross-section of various shapes (e.g., rectangular, octagonal) and various diameters and still be within the scope of this disclosure.

The exhaust pipe 412 may have a length of approximately 12 to 16 feet. The diameter size of the exhaust pipe 412 may impact the amount of drying that occurs. A higher air volume and/or faster moving air in the exhaust pipe 412 may increase the amount of moisture removed from the material. The air and vapor travel to a cyclone 414 where they are separated from the solid material.

A pulverization event generates heat that assists in drying the material. In addition to pulverization, rotation of the airflow generator 432 generates heat. The dimensions between the housing 435 and the airflow generator 432 may be configured such that during rotation the friction generates heat. The heat may exit through the housing outlet and exhaust pipe 412 and further dehydrate the material as the material travels to the cyclone 414. The generated heat may also be sufficient to partially sterilize the material in certain applications. The diameter of the housing outlet may be increased or decreased to adjust the resistance and the amount of heat traveling through the housing outlet and exhaust pipe 412. Any of the various dimensions provided herein may be adapted for a particular application, and are provided merely as examples of use in some embodiments.

The pulverization and moisture extraction increases as the airflow generated by the airflow generator 432 increases. If airflow is increased or decreased, the diameter of the exhaust pipe 412 and housing outlet may be decreased to provide the same material dehydration. Thus, the airflow and diameters may be adjusted relative to one another to achieve the desired dehydration.

Heavier materials with less water, such as rock materials, require less moisture extraction. With such materials, the housing outlet and exhaust pipe 412 diameters may be increased, as less drying is required. When operating the system with materials containing a higher percentage of liquid, the housing outlet and the exhaust pipe 412 diameters may be decreased to increase the amount of air and heat to achieve the proper dehydration of the material. In some embodiments, the diameters and lengths of the exhaust pipe 412, housing outlet, air speeds, and/or air volumes may be dynamically adjusted based on user or automatic settings for a particular material, a moisture sensor reading, and/or a desired dehydration.

The angle of inclination of the exhaust pipe 412 relative to the longitudinal axis of the venturi 418 and airflow generator 432 may also affect the dehydration performance. The exhaust pipe angle α may be approximately 25 to approximately 90 degrees in order to enhance moisture extraction. Material traveling upward is held back by gravity whereas air is less restricted by gravity. This allows the air to move faster than the material and increase moisture removal. The angle α may be adjusted to increase or decrease the effect on moisture extraction. The exhaust pipe 412 may be straight as illustrated or curved as shown in phantom.

The cyclone 414 may be used for separating particles from an airflow. The cyclone 414 typically includes a settling chamber in the form of a vertical cylinder 416. Cyclones can be embodied with a tangential inlet, axial inlet, peripheral discharge, or an axial discharge. The airflow and particles enter the cylinder 416 through an inlet 418 and spin in a vortex as the airflow proceeds down the cylinder 416. A cone section 421 causes the vortex diameter to decrease until the gas reverses on itself and spins up the center to an outlet 423. Particles are centrifuged toward the interior wall and collected by inertial impingement. The collected particles flow down in a gas boundary layer to a cone apex 424 where it is discharged through an air lock 426 and into a collection hopper 428.

In some embodiments, the system 400 may further include a condenser 431 to receive the airflow from the cyclone 414. The condenser 431 condenses the vapor in the airflow into a liquid which is then deposited in a tank 429. An outlet 434 couples to the condenser 431 and provides an exit for air. As can be appreciated, the condenser 431 has particular application with food processing. In an alternative embodiment, the condenser 431 is embodied as an alternative treatment device such as a charcoal filter or the like. As can be appreciated, condensation or filtering will depend on the material and application. The outlet 434 may include or couple to a filter (not shown) to separate residue, particles, vapor, etc. from the outputted air. The filter may be sufficient to comply with governmental regulatory standards to provide a negligible impact on the environment. According to various embodiments, combustible gases and other relatively valuable gases may be collected and stored.

Passing material through the system 400 multiple times will further dehydrate material and reduce particle size. In municipal waste applications, multiple cycles through the system 400 may be required to achieve the desired dehydration results. The present disclosure contemplates the use of multiple systems 400 in series to provide multiple venturis 418 and multiple pulverization events. Thus, a single cycle through multiple systems 400 in series achieves the desired results. Alternatively, material may be processed and reprocessed by the same system 400 until the desired particle size and dryness is achieved.

In one embodiment, the resulting product issuing from a system 400 is analyzed to determine the size of the powder granules and/or the moisture percentage. If the product fails to meet a threshold value for size and/or liquid percentage, the product is directed through one or more cycles until the product meets the desired parameters.

System 400 may also allow homogenization of different materials. In operation, different materials enter the inlet tube 412 together, are processed through the venturi 418, and undergo pulverization. The resulting product is blended and homogenized as well as being dehydrated and reduced in size.

A particular application of the presently described systems and methods involves the homogenization of landfill product with coal. After pulverization and liquid extraction, the combined and homogenized waste and coal product may increase the energy stored within output powder. Coal may also be used to initially increase the percentage of solids in sewage sludge in order to prepare the sewage sludge for initial processing. The waste is used for energy production rather than for routine disposal.

If desired, the material may be mixed in the blender 402 prior to pulverization or at an intermediate stage between pulverization events. Mixing materials may enhance homogenization with certain materials. If desired, the material may be mixed in the blender 402 prior to pulverization or at an intermediate stage between pulverization events.

Materials blended in a preprocessing stage may be cycled through multiple pulverizing stages to provide the desired homogenization. A first material may be processed through multiple pulverizing stages and then homogenized with a second material, such as a higher-grade combustible. Between pulverizing stages, the second material may be blended with the processed material in a preprocessing stage. The first and second materials may then be passed through one or more pulverizing stages to produce a homogenized final product.

As an additional example, a first material may cycle through three pulverizing stages. After the third pulverizing stage, a second material may be blended together in a blender 402. Before mixing, the second material may have passed through a venturi 418 for pulverization and reduction to a desired particle size. The first and second materials may then pass together through one or more additional pulverizing stages to provide the desired moisture content, size, and homogenization for a particular application. For instance, a specific method and/or system for pyrolysis may perform more efficiently when the particle size and/or homogenization is within certain parameters.

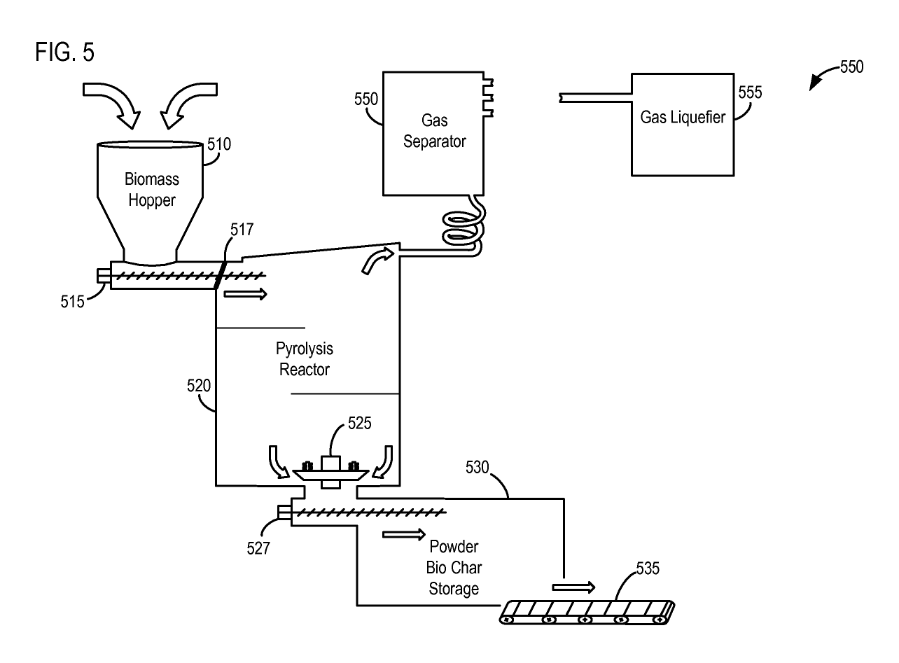

FIG. 5 illustrates a block diagram of an exemplary system 500 for performing pyrolysis on a biomass, such as sewage sludge. As illustrated, a biomass hopper 510 may be configured to receive a biomass, such as sewage sludge following pulverization and desiccation. Alternatively, sewage sludge (or another biomass) may be continuously fed into pyrolysis reactor 520. As illustrated, a screw 515 may feed the powdered sewage into the pyrolysis reactor 520. Within the pyrolysis reactor 520, the powdered sewage may undergo pyrolysis using any of a wide variety of systems and/or methods. For example, pyrolysis may include partial combustion of the biomass through air injection, direct heat transfer with hot gas, indirect heat transfer, and/or direct heat transfer with circulating solids. Moreover, various methods of flash pyrolysis of the powdered sewage may be utilized, including circulating fluidized beds, fluidized beds, rotating cones, cyclones, ablation of the particles against a hot surface, and/or through mechanical means such as augers and presses.

Following pyrolysis, the powdered char may be removed, at 525, and fed into a powder bio char storage area 530 via screw 527. According to various embodiments, the combustible powdered char may be transported for later use as a fuel. As illustrated in the exemplary block diagram, conveyers 535 may be used to transport the powdered char.

Additionally, gases generated during pyrolysis may be collected and separated within a gas separator 550. According to various embodiments, some or all of the gases may be collected. Specifically, those gases that are useful as combustible fuels and/or in various industrial applications may be collected. According to various embodiments, the collected and/or separated gases may be liquefied within gas liquefier 555.

Additionally, according to one embodiment, a specialized method of pyrolysis may be utilized that reduces the presence of harmful tars, creates a higher quality carbon, produces a syngas that may be used as diesel or jet fuel, and/or is more efficient. For example, some gases generated during pyrolysis may be filtered to reduce harmful emissions.

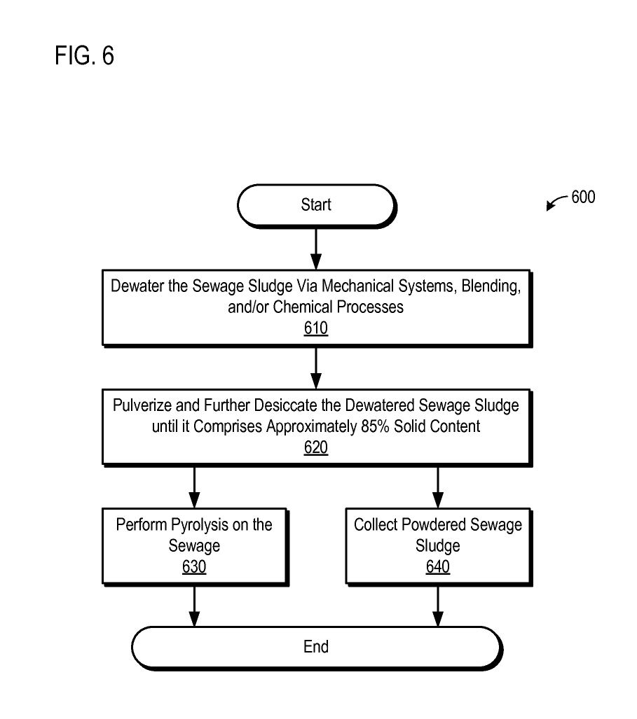

FIG. 6 provides a flow chart of an exemplary method 600 for converting raw sewage, or other biomass, into a transportable combustible fuel. Initially, the sewage sludge may be dewatered via one or more mechanical processes, at 610. Any of the various dewatering processes described herein may be utilized. In some embodiments, rather than mechanical dewatering, a natural dewatering process may be used, such as solar drying. The dewatered sewage sludge may be pulverized and/or further desiccated, at 620. The pulverized sewage may undergo pyrolysis, at 630, to form a biomass char. Alternatively, the powdered sewage sludge may be collected, at 640, for subsequent use or disposal.

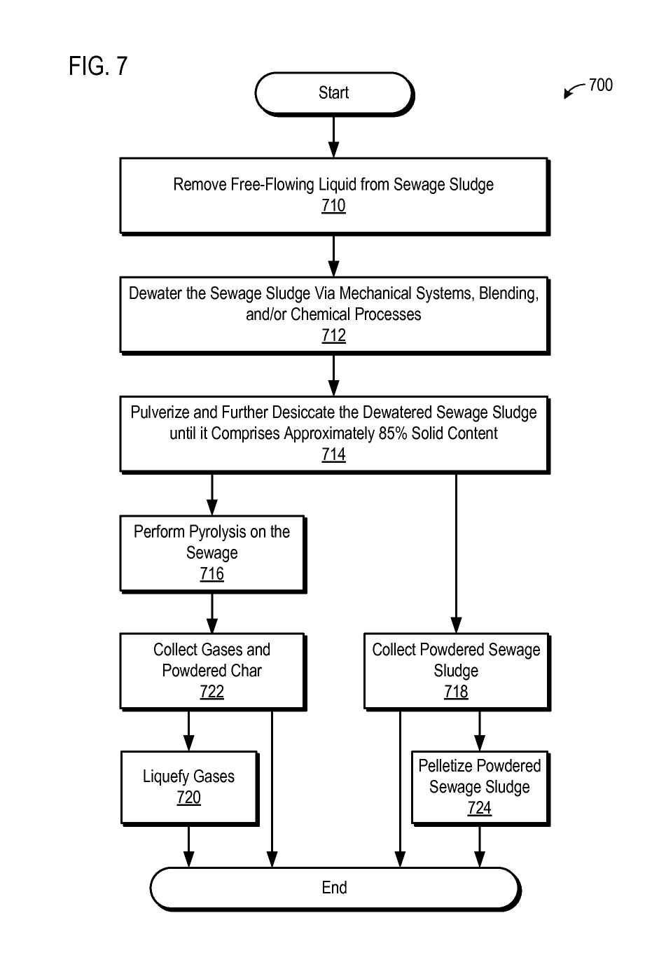

FIG. 7 provides a flow chart of an exemplary method 700 for converting raw sewage, or other biomass, into a transportable combustible fuel. As previously described, a preprocessing step may include removing free-flowing liquid from the sewage, at 710. The sewage sludge may then be dewatered via mechanical processes, at 712. Alternatively, the sewage sludge may be naturally dewatered, such as through solar drying. The dewatered sewage sludge may then be pulverized and/or further desiccated, at 714. Powdered sewage sludge, at 618, may be collected and/or pelletized for later use, at 724.

Alternatively, the pulverized and desiccated sewage may undergo pyrolysis, at 716. Powdered char and gases, at 722, generated during pyrolysis may be collected. Particularly, resulting chars and gases that can be later used as combustible fuels may be collected and stored. The collected gases, particularly those that may be used as combustibles, may be liquefied, at 720, for later use. As illustrated, a raw sewage may be converted into a combustible fuel that may be easily transported and later burned.

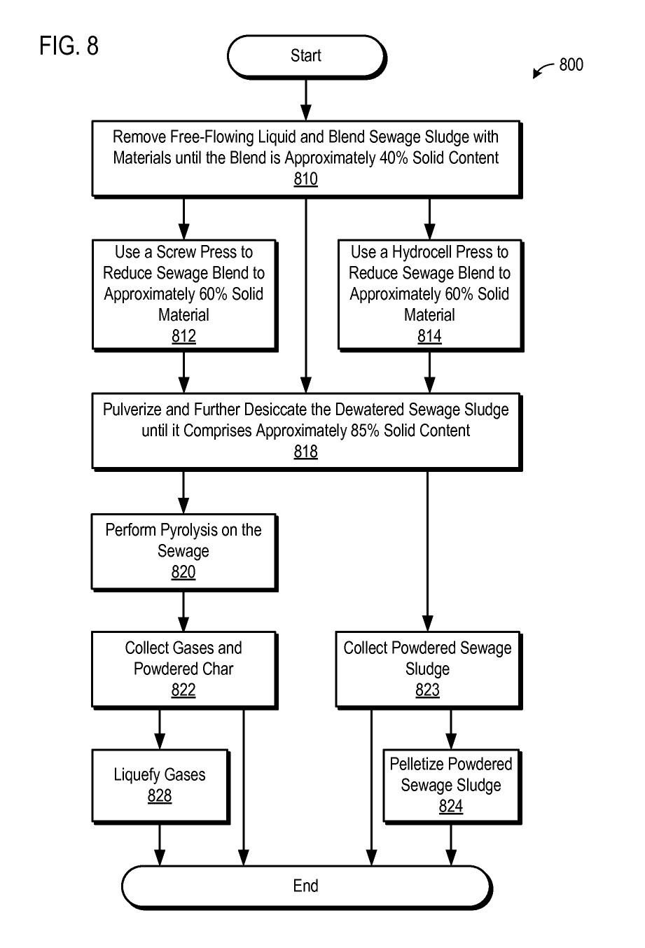

FIG. 8 provides a flow chart of another exemplary method 800 for converting raw sewage, or other biomass, into a combustible fuel. An initial preprocessing step may include removing free-flowing liquids from the sewage and blending the sewage sludge with other materials until the blended sewage sludge is approximately 40 percent solid content, at 810. Subsequently, one or more mechanical dewatering systems, at 812 and 814, may be used alone or in combination to further reduce the percentage of liquid in the sewage sludge. According to various embodiments, raw sewage may contain between 90 and 99 percent liquid content prior to removing free-flowing liquid. Following the removal of free-flowing liquid from the sewage, the sewage sludge may contain between 75 and 90 percent liquid content. A combination of mechanical systems may be utilized to reduce the percentage of liquid content in the sewage sludge to 40 percent or less.

As illustrated, a screw press, at 812, a Hydrocell press, at 814, and/or a blending system may be used to dewater the sewage sludge until it is approximately 60 percent solid content. According to various embodiments, any combination of the mechanical dewatering systems and/or improvements thereto may be utilized in order to sufficiently dewater the sewage sludge. According to various alternative embodiments, the desired percentage of solid content in the sewage sludge may be adapted for a particular pulverizing system. For example, some pulverizing systems may perform more efficiently when a lower or higher percentage of solids content is present in the sewage sludge.

Following the mechanical dewatering, a pulverizing system such as the PulverDryer manufactured by PulverDryer USA, Inc., may be utilized to pulverize and further desiccate the dewatered sewage sludge, at 818. According to various embodiments, dewatered sewage sludge may be pulverized multiple times until a desired particle size and/or dryness is achieved. According to some embodiments, a PulverDryer system may be used to convert sewage sludge comprising between 40 and 60 percent solid content into powdered sewage containing 75 percent or more solid content. The resulting powdered sewage may be collected, at 823, and/or pelletized, at 824, for later use and/or transport.

Following pulverization and desiccation, the powdered sewage may be subjected to pyrolysis, at 820. Powdered char and gases, at 822, generated during pyrolysis may be collected. Particularly, resulting chars and gases that can be later used as combustible fuels may be collected and stored. The collected gases, particularly those that may be used as combustibles, may be liquefied, at 828, for later use.

The above description provides numerous specific details for a thorough understanding of the embodiments described herein. However, those of skill in the art will recognize that one or more of the specific details may be omitted, modified, and/or replaced by a similar process, system, or component. In many instances, the order of steps and/or actions of the methods of use described herein may be interchanged with one another.

What is claimed:

1. A method of converting a biomass into a transportable fuel, comprising:
receiving a biomass having an initial composition of solid material and liquid material, wherein the percentage of solid material in the initial composition of the biomass is between 1 and 85 percent;
dewatering the biomass by compression to decrease the percentage of liquid material in the biomass;
propelling the dewatered biomass through a venturi using an airflow to pulverize the dewatered biomass and further decrease the percentage of liquid material in the biomass;
performing pyrolysis on the pulverized biomass to generate a biomass char; and
collecting the biomass char generated from pyrolysis.

2. The method of claim 1, further comprising removing free-flowing liquid from a biomass to form a biomass sludge prior to dewatering the biomass.

3. The method of claim 1, wherein the mechanical system comprises a screw press.

4. The method of claim 1, wherein dewatering the biomass by compression comprises:
dewatering the biomass via a first mechanical compression machine;
after dewatering the biomass by the first mechanical compression machine, mixing the biomass with a compressible blending material, such the blending material is distributed throughout the biomass;
providing a compression apparatus including a compression ram and a plate press, the plate press comprising a plurality of apertures vertically disposed below the compression ram to enable gravitational pull of water through the apertures;
disposing a porous material on the plate press to cover the plurality of apertures; disposing the mixture of sludge and blending material on the porous material and below the compression ram; and
the compression ram compressing the mixture of sludge and blending material against the porous material and the plate press to release water through the apertures.

5. The method of claim 1, wherein dewatering the biomass comprises blending a material with the biomass.

6. The method of claim 5, wherein blending the material with the biomass comprises blending one of a polymer, a wood-based material, and coal with the biomass.

7. The method of claim 5, wherein blending the material with the biomass comprises blending a biomass char with the biomass.

8. The method of claim 1, wherein the pyrolysis comprises flash pyrolysis.

9. The method of claim 1, further comprising collecting a gas released from the biomass as the dewatered biomass undergoes pyrolysis.

10. The method of claim 1, further comprising collecting a gas released during pyrolysis.

11. The method of claim 10, further comprising liquefying the collected gas released during pyrolysis.

12. The method of claim 10, wherein the gas comprises a syngas with no added sulfur.

13. The method of claim 1, wherein the dewatered biomass comprises at least 40 percent solid material by volume.

14. The method of claim 1, wherein the dewatered biomass comprises at least 40 percent solid material by weight.

15. The method of claim 1, wherein the pulverized biomass comprises at least 80 percent solid material by weight.

16. The method of claim 1, wherein the pulverized biomass comprises at least 80 percent solid material by volume.

17. The method of claim 1, wherein the biomass comprises sewage.

18. The method of claim 1, further comprising removing harmful tars from the biomass prior to performing pyrolysis on the pulverized biomass.

19. A method of converting a biomass into a transportable fuel, comprising:
receiving a biomass having an initial composition of solid material and liquid material, wherein the percentage of solid material in the initial composition of the biomass is between 1 and 85 percent;
dewatering the biomass by compression to decrease the percentage of liquid material in the biomass;
propelling the dewatered biomass through a venturi using an airflow to pulverize the dewatered biomass and further decrease the percentage of liquid material in the biomass;
collecting the pulverized biomass; and
using the collected pulverized biomass as a combustible fuel.

20. The method of claim 19, further comprising pelletizing the pulverized biomass.

21. The method of claim 19, further comprising removing free-flowing liquid from a biomass to form a biomass sludge prior to dewatering the biomass.

22. The method of claim 19, wherein the mechanical system comprises a screw press.

23. The method of claim 19, wherein dewatering the biomass by compression comprises:
dewatering the biomass via a first mechanical compression machine;
after dewatering the biomass by the first mechanical compression machine, mixing the biomass with a compressible blending material, such the blending material is distributed throughout the biomass;
providing a compression apparatus including a compression ram and a plate press, the plate press comprising a plurality of apertures vertically disposed below the compression ram to enable gravitational pull of water through the apertures;
disposing a porous material on the plate press to cover the plurality of apertures; disposing the mixture of sludge and blending material on the porous material and below the compression ram; and

24. The method of claim 19, wherein dewatering the biomass comprises blending a material with the biomass.

25. The method of claim 24, wherein blending the material with the biomass comprises blending one of a polymer, a wood-based material, and coal with the biomass.

26. The method of claim 24, wherein blending the material with the biomass comprises blending a biomass char with the biomass.

27. The method of claim 19, wherein the pyrolysis comprises flash pyrolysis.

28. The method of claim 19, further comprising collecting a gas released from the biomass as the dewatered biomass is pulverized.

29. The method of claim 19, wherein the dewatered biomass comprises at least 40 percent solid material by volume.

30. The method of claim 19, wherein the dewatered biomass comprises at least 40 percent solid material by weight.

31. The method of claim 19, wherein the pulverized biomass comprises at least 80 percent solid material by weight.

32. The method of claim 19, wherein the pulverized biomass comprises at least 80 percent solid material by volume.

33. The method of claim 19, wherein the biomass comprises sewage.

34. A system for converting biomass into a transportable fuel, comprising:
a press system configured to dewater a biomass to decrease the percentage of liquid in the biomass to less than approximately 60 percent;
a pulverizing machine comprising:
an inlet tube configured to receive the dewatered biomass;
an airflow generator configured to generate an airflow to propel the dewatered biomass through a venturi in the pulverizing machine to pulverize the dewatered biomass;
a pyrolysis machine configured to perform pyrolysis of the pulverized biomass to generate a biomass char; and
a collection system for collecting the biomass char.

35. The system of claim 34, wherein the press system comprises a screw press.

36. The system of claim 34, wherein the press system comprises a compression apparatus, the compression apparatus comprising:
a plate press configured with a plurality apertures configured to enable the gravitational pull of liquid through the apertures;
a porous material disposed on the plate press to cover the plurality of apertures; and
a compression ram configured to compress the biomass against the plate press to release liquid through the apertures.

37. The system of claim 34, further comprising a blender configured to blend the biomass with a blending material.

38. The system of claim 37, wherein the blender is configure to blend one of a polymer, a wood-based material, and coal with the biomass.

39. The system of claim 37, wherein the blender is configure to blend a biomass char previously generated by the system with the biomass.

40. The system of claim 34, wherein the pyrolysis machine configured to perform a flash pyrolysis of the pulverized biomass to generate a biomass char.

41. The system of claim 34, wherein the pyrolysis machine configured to perform a flash pyrolysis of the pulverized biomass to generate a biomass char.

42. The system of claim 34, further comprising a gas collection system configured to collect a gas released from the biomass during pyrolysis.

43. The system of claim 42, further comprising a gas liquefaction system configured to liquefy the collected gas.

44. The system of claim 42, wherein the gas comprises a syngas with no added sulfur.

45. The system of claim 34, wherein the dewatered biomass comprises at least 40 percent solid material by volume.

46. The system of claim 34, wherein the dewatered biomass comprises at least 40 percent solid material by weight.

47. The system of claim 34, wherein the pulverized biomass comprises at least 80 percent solid material by weight.

48. The system of claim 34, wherein the pulverized biomass comprises at least 80 percent solid material by volume.

49. The system of claim 34, wherein the biomass comprises sewage.

50. The system of claim 34, further comprising a tar removal system configured to remove harmful tars from the biomass prior to performing pyrolysis on the pulverized biomass.

51. A system for converting biomass into a transportable fuel, comprising:
a press system configured to dewater a biomass to decrease the percentage of liquid in the biomass to less than approximately 60 percent;
a pulverizing machine comprising:
an inlet tube configured to receive the dewatered biomass;
an airflow generator configured to generate an airflow to propel the dewatered biomass through a venturi in the pulverizing machine to pulverize the dewatered biomass;
a collection system for collecting the pulverized biomass; and
a pelletizing machine configured to pelletized the pulverized biomass for subsequent use as a combustible fuel.

52. The system of claim 51, wherein the press system comprises a screw press.

53. The system of claim 51, wherein the press system comprises a compression apparatus, the compression apparatus comprising:
a plate press configured with a plurality apertures configured to enable the gravitational pull of liquid through the apertures;
a porous material disposed on the plate press to cover the plurality of apertures; and
a compression ram configured to compress the biomass against the plate press to release liquid through the apertures.

54. The system of claim 51, further comprising a blender configured to blend the biomass with a blending material.

55. The system of claim 54, wherein the blender is configure to blend one of a polymer, a wood-based material, and coal with the biomass.

56. The system of claim 54, wherein the blender is configure to blend a biomass char previously generated by the system with the biomass.

57. The system of claim 51, wherein the dewatered biomass comprises at least 40 percent solid material by volume.

58. The system of claim 51, wherein the dewatered biomass comprises at least 40 percent solid material by weight.

59. The system of claim 51, wherein the pulverized biomass comprises at least 80 percent solid material by weight.

60. The system of claim 51, wherein the pulverized biomass comprises at least 80 percent solid material by volume.

61. The system of claim 51, wherein the biomass comprises sewage.

62. The system of claim 51, further comprising a tar removal system configured to remove harmful tars from the biomass following pulverization.
